(19) United States
(12) Patent Application Publication
(10) Pub. No.: US 2008/0179016 A1
(43) Pub. Date: Jul. 31, 2008

(54) Blind device

(76) Inventor: Ya-Yin Lin, Chia-Yi Hsien (TW)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/657,665

(22) Filed: Jan. 25, 2007

(51) Int. Cl. E06B 3/00

(52) U.S. Cl. 160/84.01

(57) ABSTRACT

A blind device includes a flexible screen body with interconnected shielding sections, and a counterweight unit provided on a lowermost one of the shielding sections. The counterweight unit includes a horizontally extending top bar retained at a top edge of the lowermost shielding section, a horizontally extending bottom bar retained at a bottom edge of the lowermost shielding section, and at least one foldable component connected to the top and bottom bars and convertible from an unfolded state, where the lowermost shielding section is stretched by the counterweight unit in a vertical direction, to a folded state, where the counterweight unit folds the lowermost shielding section in the vertical direction.

### BACKGROUND OF THE INVENTION

1. Field of the Invention

The invention relates to a blind device, more particularly to a blind device having a screen body that can be furled and unfurled.

2. Description of the Related Art

A conventional blind device includes a flexible screen body that can be furled and unfurled, and a counterweight unit provided on the screen body to balance the winding force of a winding mechanism. Since the counterweight unit of the conventional blind device is provided fixedly on the screen body and is not foldable, packaging material and storage space requirements of the conventional blind device are large.

### SUMMARY OF THE INVENTION

Therefore, the object of the present invention is to provide a blind device having a screen body that can be furled and unfurled, and a counterweight unit with components that are foldable relative to the screen body to reduce packaging material and storage space requirements of the blind device.

According to the present invention, a blind device includes a top frame member, a flexible screen body, a positioning unit, a furling controller, and a counterweight unit.

The screen body can be furled and unfurled, and has a top end connected to the top frame member. The screen body includes a plurality of shielding sections arranged in a vertical column. Adjacent ones of the shielding sections are interconnected.

The positioning unit includes a plurality of pairs of horizontally spaced apart left and right ring components. Each of the pairs of the ring components is disposed at a junction of a corresponding adjacent pair of the shielding sections.

The furling controller includes a winding mechanism mounted on the top frame member, and left and right pull cords connected to the winding mechanism. The left pull cord passes in sequence through the left ring components. The right pull cord passes in sequence through the right ring components. The left and right pull cords have distal ends connected to a top edge of a lowermost one of the shielding sections. The winding mechanism applies a winding force on the pull cords.

The counterweight unit is provided on the lowermost one of the shielding sections to balance the winding force of the winding mechanism. The counterweight unit includes a horizontally extending top bar retained at the top edge of the lowermost one of the shielding sections, a horizontally extending bottom bar retained at a bottom edge of the lowermost one of the shielding sections, and at least one foldable component connected to the top and bottom bars and convertible from an unfolded state, where the lowermost one of the shielding sections is stretched by the counterweight unit in a vertical direction, to a folded state, where the counterweight unit folds the lowermost one of the shielding sections in the vertical direction.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view of the first preferred embodiment of a blind device according to the present invention;

FIG. 2 is a fragmentary exploded perspective view of a counterweight unit of the first preferred embodiment;

FIG. 3 is a sectional view of the counterweight unit of the first preferred embodiment;

FIG. 4 is a schematic view to illustrate how a foldable component of the counterweight unit of the first preferred embodiment is folded;

FIG. 5 is a schematic view to illustrate a fully furled state of a screen body of the first preferred embodiment;

FIG. 6 is a fragmentary exploded perspective view of a counterweight unit of the second preferred embodiment of a blind device according to the present invention; and

FIG. 7 is a schematic view to illustrate how a foldable component of the counterweight unit of the second preferred embodiment is folded.

### DETAILED DESCRIPTION OF THE PREFERRED EMBODIMENTS

Before the present invention is described in greater detail with reference to the preferred embodiments, it should be noted herein that like elements are denoted by the same reference numerals throughout the disclosure.

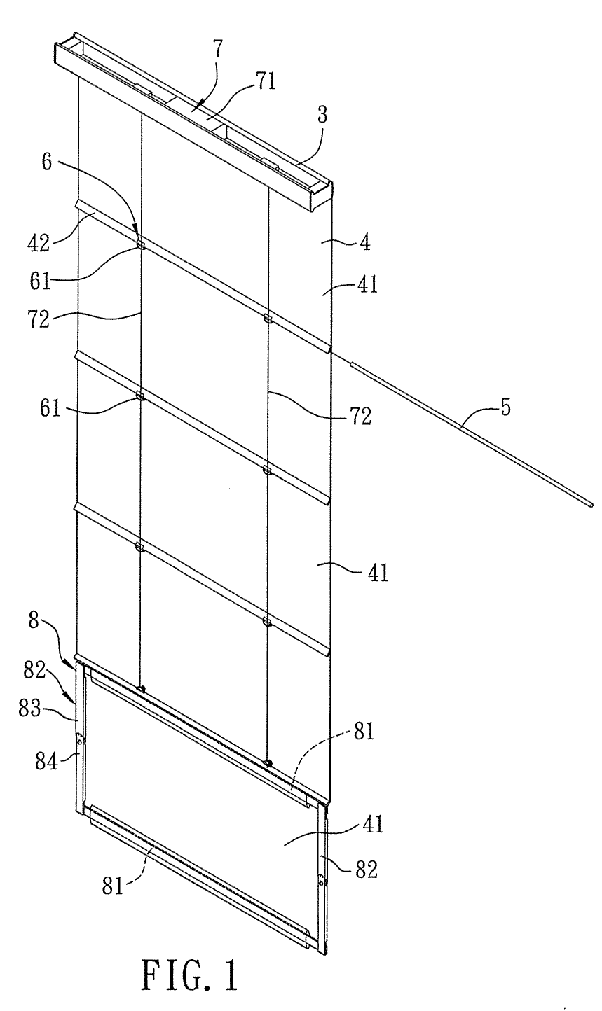

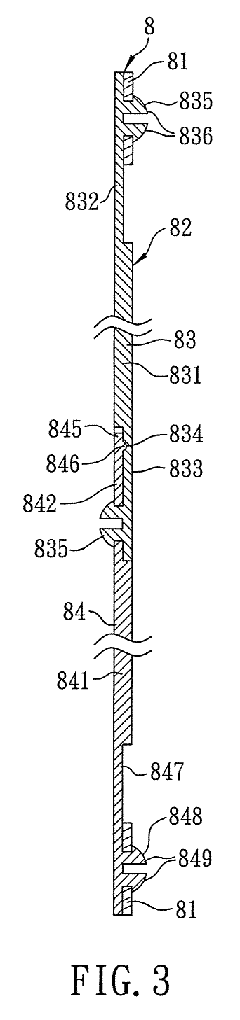

Referring to FIGS. 1 to 3, the first preferred embodiment of a blind device according to the present invention is shown to comprise a top frame member 3 that can be fixed to a wall (not shown), a flexible screen body 4 that can be furled and unfurled and that has a top end connected fixedly to the top frame member 3, a plurality of horizontally extending and vertically spaced apart lifting rods 5 provided on the screen body 4, a positioning unit 6 disposed on a rear side of the screen body 4, a furling controller 7 mounted on the top frame member 3 and operable to furl the screen body 4, and a counterweight unit 8 provided on a lowermost part of the screen body 4.

The screen body 4 includes a plurality of shielding sections 41 arranged in a vertical column and having equal vertical lengths. Adjacent ones of the shielding sections 41 are interconnected and are provided with a horizontally extending rod-receiving pocket 42 at a junction thereof. In this embodiment, the screen body 4 is made of a fabric material, such as cotton or silk.

Each lifting rod 5 is inserted removably into a respective one of the rod-receiving pockets 42. The positioning unit 6 includes a plurality of pairs of horizontally spaced apart left and right ring components 61. Each pair of the ring components 61 clamps removably a corresponding lifting rod 5. In practice, the lifting rods 5 are optional and may be omitted in other embodiments of this invention.

The furling controller 7 includes a winding mechanism 71 mounted on the top frame member 3, and left and right pull cords 72 connected to the winding mechanism 71. The left pull cord 72 passes in sequence through the left ring components 61, and the right pull cord 72 passes in sequence through the right ring components 61. The left and right pull cords 72 have distal ends connected to a top edge of the lowermost shielding section 41. The winding mechanism 71 applies a winding force on the pull cords 72.

In this embodiment, the counterweight unit 8 includes horizontally extending top and bottom bars 81 respectively retained at top and bottom edges of the lowermost shielding section 41, and left and right foldable components 82 that interconnect adjacent ends of the top and bottom bars 81 and that are disposed at a rear side of the screen body 4. The foldable components 82 are convertible from an unfolded state, where the lowermost shielding section 41 is stretched by the counterweight unit 8 in a vertical direction, to a folded state, where the counterweight unit 8 folds the lowermost shielding section 41 in the vertical direction. The weights of the top and bottom bars 81 are selected to balance the winding force applied by the winding mechanism 71 on the pull cords 72 so that the bottom edge of the lowermost shielding section 41 can be held releasably at an arbitrary height in a conventional manner. Each of the top and bottom bars 81 has left and right end parts formed with a respective through hole 810.

Each of the left and right foldable components 82 includes pivotally interconnected upper and lower bar segments 83, 84. The upper bar segment 83 is pivoted to the top bar 81 at a respective one of the left and right end parts of the top bar 81. The lower bar segment 84 is pivoted to the bottom bar 81 at a respective one of the left and right end parts of the bottom bar 81.

The upper bar segment 83 includes a first bar body 831, a first coupling plate 832 extending from an upper end of the first bar body 831, a second coupling plate 833 extending from a lower end of the first bar body 831, a pair of first pivot retainers 835 that project respectively from the first and second coupling plates 832, 833, and a limit projection 837 formed on the second coupling plate 833.

The first coupling plate 832 has a coupling side that is recessed relative to a front side 8310 of the first bar body 831. The second coupling plate 833 has a coupling side that is recessed relative to a rear side 8311 of the first bar body 831. Each of the first pivot retainers 835 projects from the coupling side of the respective one of the first and second coupling plates 832, 833. In this embodiment, each of the first pivot retainers 835 includes a pair of resilient anchor arms 836, each of which has a distal end formed with a retaining flange 8361. The limit projection 837 projects from the coupling side of the second coupling plate 833 at one edge of the second coupling plate 833 distal from the other one of the foldable components 82. The coupling side of the second coupling plate 833 is further formed with a positioning groove 834, which is disposed above the anchor arms 836 on the coupling side of the second coupling plate 833 in this embodiment.

The lower bar segment 84 includes a second bar body 841, a third coupling plate 842 extending from an upper end of the second bar body 841, a fourth coupling plate 847 extending from a lower end of the second bar body 841, a convex positioning projection 846 formed on the third coupling plate 842, and a second pivot retainer 848 that projects from the fourth coupling plate 847.

Each of the third and fourth coupling plates 842, 847 has a coupling side that is recessed relative to a front side 8410 of the second bar body 841. The third coupling plate 842 is formed with a pair of parallel slits 843 that extend from a top edge of the third coupling plate 842 to thereby configure the third coupling plate 842 with a resilient arm 845 between the slits 843, and is further formed with a pivot hole 844 that is disposed below the resilient arm 845. The positioning projection 846 is formed on the resilient arm 845 and is disposed at the coupling side of the third coupling plate 842. The second pivot retainer 848 projects from the coupling side of the fourth coupling plate 847. In this embodiment, the second pivot retainer 848 has a structure similar to that of the first pivot retainers 835, and includes a pair of resilient anchor arms 849, each of which has a distal end formed with a retaining flange 8491.

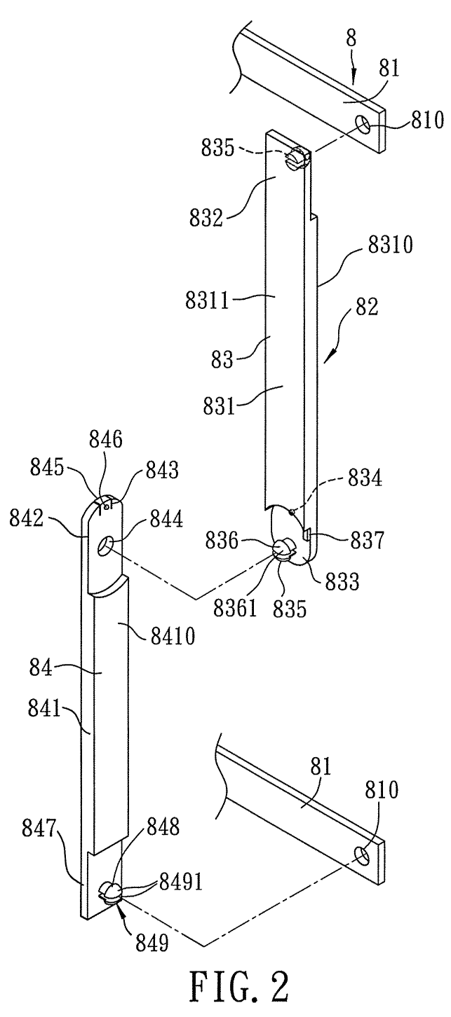

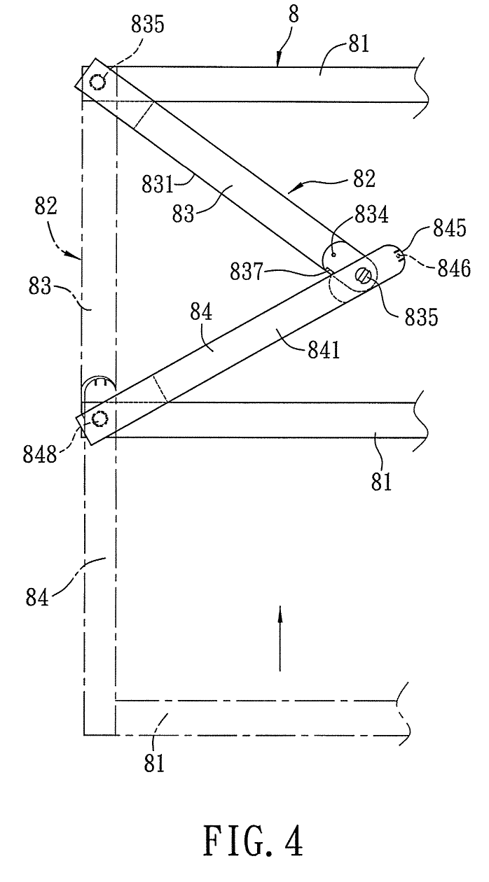

Referring to FIGS. 2, 3 and 4, to assemble the counterweight unit 8, the coupling side of the third coupling plate 842 of each lower bar segment 84 is brought toward the coupling side of the second coupling plate 833 of the corresponding upper bar segment 83, and the anchor arms 836 of the first pivot retainer 835 on the second coupling plate 833 are extended through the pivot hole 844 in the third coupling plate 842 such that the retaining flanges 8361 on the anchor arms 836 abut against the opposite side of the third coupling plate 842, thereby interconnecting pivotally the upper and lower bar segments 83, 84. Next, the first pivot retainer 835 on the first coupling plate 832 of each upper bar segment 83 is extended through the through hole 810 in the respective one of the left and right end parts of the top bar 81 to connect pivotally the upper bar segments 83 of the foldable components 82 to the top bar 81, and the second pivot retainer 848 on the fourth coupling plate 847 of each lower bar segment 84 is extended through the through hole 810 in the respective one of the left and right end parts of the bottom bar 81 to connect pivotally the lower bar segments 84 of the foldable components 82 to the bottom bar 81.

When the foldable components 82 are in the unfolded state, the upper and lower bar segments 83, 84 of each of the foldable components 82 form a straight line, the third coupling plate 842 of each lower bar segment 84 abuts against the limit projection 837 on the second coupling plate 833 of the corresponding upper bar segment 83 so as to be limited thereby, and the positioning projection 846 on the third coupling plate 842 of each lower bar segment 84 engages the positioning groove 834 in the second coupling plate 833 of the corresponding upper bar segment 83 so as to retain releasably the foldable components 82 in the unfolded state. The lowermost shielding section 41 of the screen body 4 is stretched by the counterweight unit 8 in the vertical direction at this time (see FIG. 1). Thereafter, when the blind device is mounted on a wall, furling and unfurling of the screen body 4 can be conducted by pushing the bottom bar 81 upward or pulling the bottom bar 81 downward. Referring again to FIG. 1, when the bottom bar 81 is pushed upward, the lowermost shielding section 41 is moved upward. Due to the winding force applied by the winding mechanism 71 on the pull cords 72, upward movement of the lowermost shielding section 41 results in folding of an immediately adjacent one of the shielding sections 41. Further upward movement of the lowermost shielding section 41 results in eventual abutment between the top bar 81 and one of the pairs of the ring components 61 in preparation for folding another one of the shielding sections 41. The shielding sections 41 are thus folded in sequence from bottom to top in the aforementioned manner when the bottom bar 81 is pushed upward.

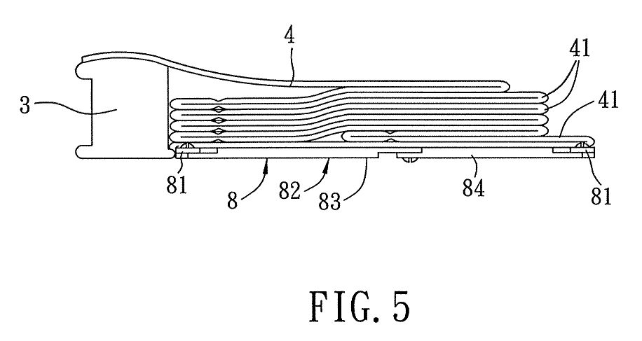

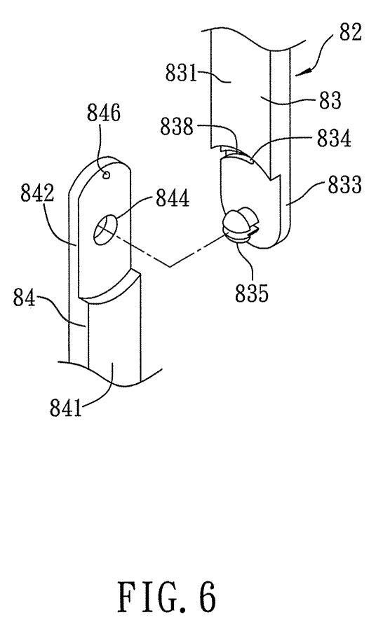

When the screen body 4 is furled, the foldable components 82 can be folded to result in folding of the lowermost shielding section 41 in the vertical direction, thereby reducing packaging material and storage space requirements of the blind device. With further reference to FIGS. 5 and 6, the upper and lower bar segments 83, 84 of each of the foldable components 82 are forced to pivot relative to each other about the first pivot retainer 835 on the second coupling plate 833, thereby resulting in disengagement of the positioning projection 846 on the lower bar segment 84 from the positioning groove 834 in the upper bar segment 83, in corresponding pivoting movement of the upper bar segment 83 relative to the top bar 81 about the first pivot retainer 835 on the first coupling plate 832, and in corresponding pivoting movement of the lower bar segment 84 relative to the bottom bar 81 about the second pivot retainer 848 on the fourth coupling plate 847. In the folded state, the third coupling plate 842 of each lower bar segment 84 abuts against the bottom edge of the limit projection 837 on the second coupling plate 833 of the corresponding upper bar segment 83 to limit extent of folding movement of the lower bar segment 84 relative to the corresponding upper bar segment 83. Moreover, in the folded state, the distance between the top and bottom bars 81 is shortened, thereby resulting in folding of the lowermost shielding section 41 in the vertical direction.

To convert the foldable components 82 from the folded state back to the unfolded state, it is only required to pivot the upper and lower bar segments 83, 84 of each of the foldable components 82 relative to each other about the first pivot retainer 835 on the second coupling plate 833 until the positioning projection 846 on each lower bar segment 84 once again engages the positioning groove 834 in the corresponding upper bar segment 83.

It should be noted that, in other embodiments of this invention, the resilient arm 845 on the third coupling plate 842 of each lower bar segment 84 and/or the limit projection 837 on the second coupling plate 837 of each upper bar segment 83 may be omitted. Moreover, the number of the foldable components 82 between the top and bottom bars 81 may be reduced to one in further embodiments of this invention. Furthermore, the pivot connections between the upper and lower bar segments 83, 84, between the top bar 81 and the upper bar segments 83, and between the bottom bar 81 and the lower bar segments 84 should not be limited to those of the abovementioned embodiment and may be modified depending on actual requirements.

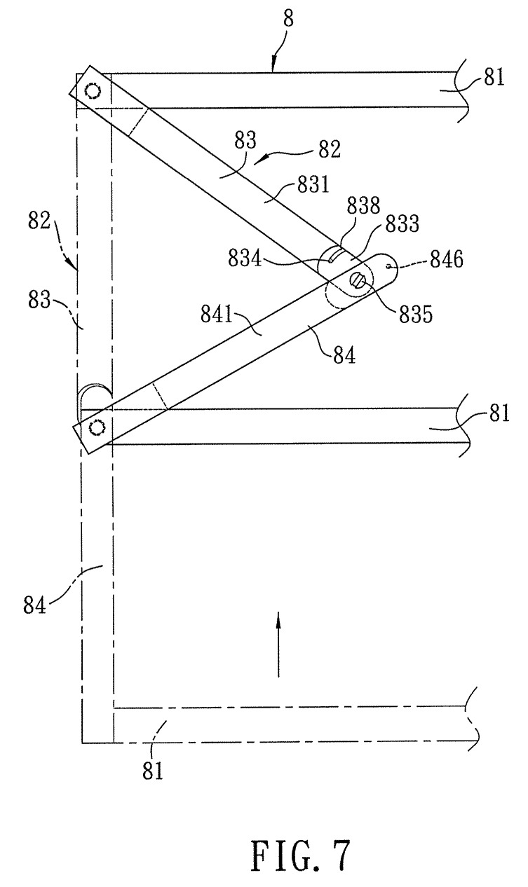

Referring to FIGS. 6 and 7, the second preferred embodiment of the blind device of this invention differs from the previous embodiment in the configuration of the foldable components 82 of the counterweight unit 8. Unlike the previous embodiment, the second coupling plate 833 of each upper bar segment 83 is not formed with the limit projection 837 but is formed instead with a curved track groove 838 that extends from the positioning groove 834 and that opens at one edge of the second coupling plate 833 proximate to the other one of the foldable components 82. The curved track groove 838 has a depth that is slightly smaller than a protruding height of the positioning projection 846 on the third coupling plate 842 of the lower bar segment 84. In addition, the third coupling plate 842 of each lower bar segment 84 is not formed with the resilient arm 845 of the previous embodiment.

The foldable components 82 are assembled to the top and bottom bars 81 in a manner similar to that described hereinabove in connection with the previous embodiment. The difference between this embodiment and the previous embodiment resides primarily in how the upper and lower bar segments 83, 84 pivot relative to each other. In particular, when converting the foldable component 82 from the folded state to the unfolded state, the upper and lower bar segments 83, 84 are pivoted about the first pivot retainer 835 on the second coupling plate 833 of the upper bar segment 83 to insert the positioning projection 846 on the lower bar segment 84 into the curved track groove 838 in the upper bar segment 83. Since the depth of the curved track groove 838 is slightly smaller than the protruding height of the positioning projection 846, a sufficient force must be applied to cause the protruding projection 846 to move along the curved track groove 838 and eventually engage the positioning groove 834, thereby retaining releasably the foldable component in the unfolded state. On the other hand, to convert the foldable component 82 from the unfolded state back to the folded state, it is only necessary to force the upper and lower bar segments 83, 84 to pivot relative to each other about the first pivot retainer 835 on the second coupling plate 833 to disengage the positioning projection 846 from the positioning groove 834 and to move the positioning projection 846 out of the curved track groove 838.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A blind device comprising:
a top frame member;
a flexible screen body that can be furled and unfurled and that has a top end connected to said top frame member, said screen body including a plurality of shielding sections arranged in a vertical column, adjacent ones of said shielding sections being interconnected;
a positioning unit including a plurality of pairs of horizontally spaced apart left and right ring components, each of said pairs of said ring components being disposed at a junction of a corresponding adjacent pair of said shielding sections;
a furling controller including a winding mechanism mounted on said top frame member and left and right pull cords connected to said winding mechanism, said left pull cord passing in sequence through said left ring components, said right pull cord passing in sequence through said right ring components, said left and right pull cords having distal ends connected to a top edge of a lowermost one of said shielding sections, said winding mechanism applying a winding force on said pull cords; and
a counterweight unit provided on said lowermost one of said shielding sections to balance the winding force of said winding mechanism;
said counterweight unit including a horizontally extending top bar retained at said top edge of said lowermost one of said shielding sections, a horizontally extending bottom bar retained at a bottom edge of said lowermost one of said shielding sections, and at least one foldable component connected to said top and bottom bars and convertible from an unfolded state, where said lowermost one of said shielding sections is stretched by said counterweight unit in a vertical direction, to a folded state, where said counterweight unit folds said lowermost one of said shielding sections in the vertical direction.

2. The blind device as claimed in claim 1, wherein said foldable component includes pivotally interconnected upper and lower bar segments, said upper bar segment being pivoted to said top bar, said lower bar segment being pivoted to said bottom bar.

3. The blind device as claimed in claim 2, wherein:
said upper bar segment includes a first bar body having upper and lower ends, a first coupling plate extending from said upper end of said first bar body and pivoted to said top bar, and a second coupling plate extending from said lower end of said first bar body; and
said lower bar segment includes a second bar body having upper and lower ends, a third coupling plate extending from said upper end of said second bar body and pivoted to said second coupling plate of said upper bar segment, and a fourth coupling plate extending from said lower end of said second bar body and pivoted to said bottom bar.

4. The blind device as claimed in claim 3, wherein one of said second and third coupling plates is formed with a positioning groove, and the other one of said second and third coupling plates is formed with a positioning projection to engage removably said positioning groove so as to retain releasably said foldable component in the unfolded state.

5. The blind device as claimed in claim 4, wherein said third coupling plate is configured with a resilient arm, said positioning projection being formed on said resilient arm.

6. The blind device as claimed in claim 4, wherein said second coupling plate is formed with a limit projection to limit extent of pivoting movement of said third coupling plate relative to said second coupling plate between the folded and unfolded states.

7. The blind device as claimed in claim 4, wherein said second coupling plate is formed with said positioning groove and is further formed with a curved track groove that extends from said positioning groove, said curved track groove receiving and guiding movement of said positioning projection when said foldable component is converted between the folded and unfolded states.

8. The blind device as claimed in claim 3, wherein:
said first bar body has a front side, and said first coupling plate has a coupling side that is recessed relative to said front side of said first bar body and that is disposed to abut against said top bar; and
said second bar body has a front side, and said fourth coupling plate has a coupling side that is recessed relative to said front side of said second bar body and that is disposed to abut against said bottom bar.

9. The blind device as claimed in claim 3, wherein:
said first coupling plate is formed with a first pivot retainer that extends through said top bar to connect pivotally said upper bar segment to said top bar; and
said fourth coupling plate is formed with a second pivot retainer that extends through said bottom bar to connect pivotally said lower bar segment to said bottom bar.

10. The blind device as claimed in claim 3, wherein:
said first bar body has a rear side, and said second coupling plate has a coupling side that is recessed relative to said rear side of said first bar body; and
said second bar body has a front side, and said third coupling plate has a coupling side that is recessed relative to said front side of said second bar body and that is disposed to abut against said coupling side of said second coupling plate.

11. The blind device as claimed in claim 3, wherein one of said second and third coupling plates is formed with a pivot retainer that extends through the other one of said second and third coupling plates to interconnect pivotally said upper and lower bar segments of said foldable component.
